(19) United States
(12) Patent Application Publication
(10) Pub. No.: US 2007/0278953 A1
(43) Pub. Date: Dec. 6, 2007

(54) Lamp Bulb

(76) Inventors: Seishirou Hagiwara, Saitama (JP); Takayuki Kameya, Saitama (JP); Go Maeda, Saitama (JP)

Correspondence Address: NIXON PEABODY, LLP, 401 9TH STREET, NW, SUITE 900, WASHINGTON, DC, 20004-2128, US

(21) Appl. No.: 10/591,251

(22) PCT Filed: Mar. 1, 2005
(86) PCT No.: PCT/JP05/03406

§ 371 Date: May 10, 2007

(30) Foreign Application Priority Data
Mar. 1, 2004 (JP) 2004-056280

(51) Int. Cl. H01K 1/00; H01K 1/50

(52) U.S. Cl. 313/578; 313/272

(57) ABSTRACT

An electric lamp which is almost free from an illumination trouble due to breakage of filaments is composed of a light transmitting bulb, a bulb base equipped with a pair of inner terminals and a pair of outer terminals, and a linear light emitting means composed of plural filaments extended in parallel with each other between the inner terminals, in which at least one filament and the other filament are disposed oppositely to each other and shielded from each other with a light transmitting shielding plate.

### FIELD OF INVENTION

This invention relates to an electric lamp which is favorably employable, particularly, as a lighting fitting used on theater stages or in broadcasting studios.

### BACKGROUND OF THE INVENTION

A variety of lighting fittings are placed on stages for theaters and concerts and broadcasting studios. A lighting fitting can be a halogen lamp. The halogen lamp is composed of a glass bulb, a base equipped with a pair of inner terminals and a pair of outer terminals, and filaments (linear light emitting means) extended between the inner terminals. The halogen lamp contains a halogen gas or a halogen compound gas in the bulb so as to keep the bulb and filaments from blackening in illumination of lamp for a period of long time.

In the case that filaments of a light-emitting electric lamp are broken during a play, concert, or a broadcasting from studio (particularly, live broadcasting) due to termination of its life time, the light supplied from the lighting ceases or decreases. In order to obviate such troubles, staffs for managing lighting fittings generally check the conditions of the filaments prior to or between the studio broadcasting or the like, or exchange electric lamps which have been used for a long period of time. However, it is not easy to learn the life times of filaments of electric bulbs, and hence it is not easy to sufficiently obviate troubles caused by breakage of filaments of electric bulb during studio broadcasting or the like. For this reason, auxiliary lighting fittings are generally arranged in the stages and broadcasting studios.

JP-A-2003-132853 discloses an electric lamp having a pair of filaments in its bulb. The publication describes that one filament is made active to give illumination and then breaks down, and subsequently other filament is made active to give illumination. Thus, the life times of the electric lamp is doubled.

### SUMMARY OF THE INVENTION

The conventional method of using auxiliary lighting fittings when active lighting fittings break down is not satisfactory, because there happens to be a time interval giving no or poor illumination between the time of breakdown of the active lighting fitting and the time of start of illumination of the auxiliary lighting fitting. Moreover, it is not advantageous to arrange auxiliary lighting fittings for all of the installed lighting fittings from the view-points of management of the lighting fittings, space for the lighting fittings, and costs.

The lighting lamp described in the above-mentioned Japanese patent publication which contains a pair of filaments in its bulb is still not satisfactory for the preparation of break-down of a filament, because there still happens to be a period of time between the time of break-down of the active filament and the time of start of illumination of another filament.

It is an object to provide an electric lamp which is almost free from the illumination trouble caused by break-down of a filament.

The present invention resides in an electric lamp comprising a light transmitting bulb, a bulb base equipped with a pair of inner terminals and a pair of outer terminals, and a linear light emitting means composed of plural filaments extended in parallel with each other between the inner terminals, in which at least one filament and the other filament are disposed oppositely to each other and shielded from each other with a light transmitting shielding plate.

Preferred embodiments according to the invention are described below.

(1) The light transmitting shielding plate shields all imaginary lines connecting the filaments disposed oppositely to each other.

(2) The linear light emitting means is composed of two filaments.

(3) The two filaments have the same electric capacity.

(4) one filament has an electric capacity less than an electric capacity of other filament. More preferably, the electric capacity of the former filament is 30% or more based on the electric capacity of latter filament.

(4) The two filaments show the same color temperature.

(5) One filament shows a color temperature higher than a color temperature of other filament.

(6) The color temperature of the former filament is higher than the color temperature of the latter filament by 100 K or less.

(7) A halogen gas or a halogen compound gas is placed in the bulb.

In the specification, the “light-transmitting” means to transmit at least 50% of a visible light.

Effect of Invention

The electric lamp of the invention generally comprises two filaments in its bulb, and both filaments are caused to light at the same time. Accordingly, even when one of the light-emitting filament breaks down, the eclectic lamp of the invention keeps illumination by the fact that another light-emitting filament keeps of emission of light. Therefore, although the luminance may vary to some extent, the illumination trouble by the break-down of a filament can be reduced.

### BRIEF DESCRIPTION OF THE DRAWING

FIG. 1 is a partly broken front view indicating a structure of an electric lamp of the invention.

FIG. 2 is a partly broken right-side view of the electric lamp of FIG. 1.

FIG. 3 is a partly broken rear view of the electric lamp of FIG. 1.

FIG. 4 is a perspective view indicating the connection between the filaments and the inner electrodes.

10: electric lamp, 11: light-transmitting bulb,

12a,12b: inner terminal, 13a,13b: outer terminal,

14: bulb base, 15a,15b: filament,

16: light-transmitting shielding plate,

17a,17b: electrode pole,

18a,18b: auxiliary electrode pole,

19a,19b: wire, 20a,20b: wire, 21a,21b: wire,

22a,22b: wire, 23: supporting pole,

24a: upper supporting glass,

24b: lower supporting glass, 25: sleeve glass,

26: fixing area.

### DETAILED DESCRIPTION OF THE INVENTION

The electric lamp of the invention is further described with reference to the attached drawings.

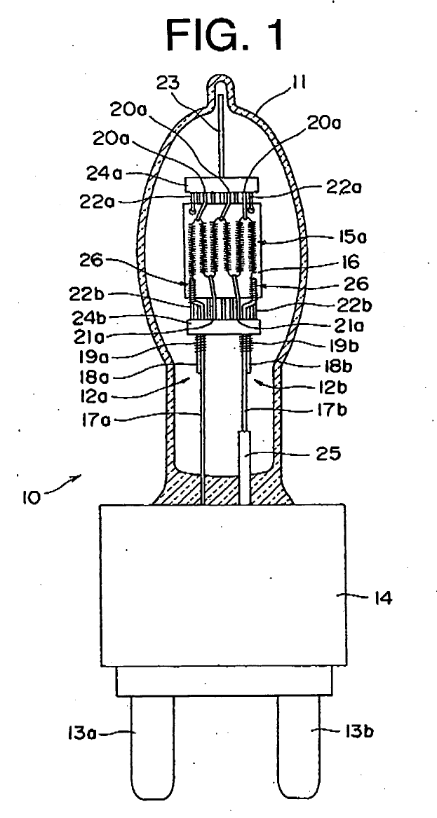

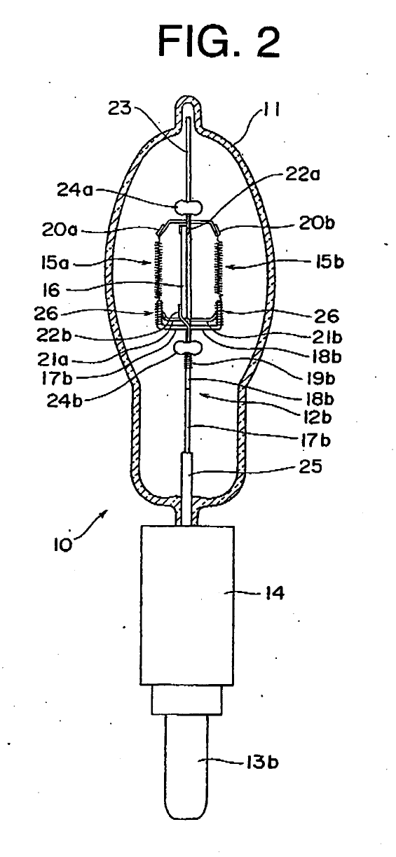

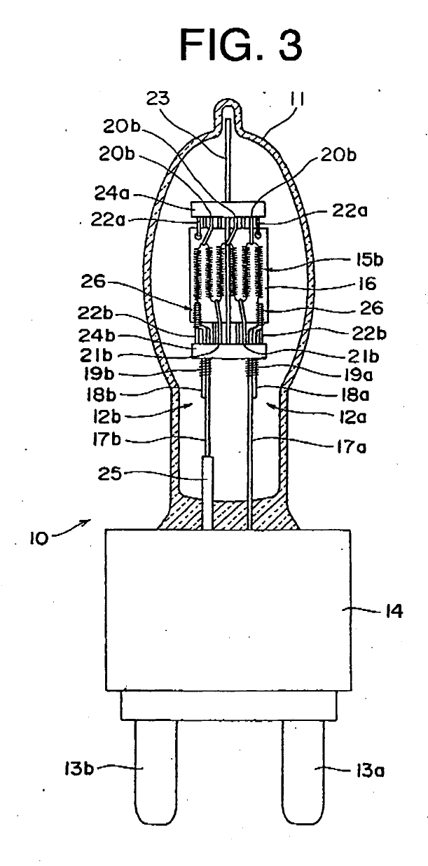

FIG. 1 is a partly broken front view indicating a structure of an electric lamp of the invention, FIG. 2 is a partly broken right-side view of the electric lamp of FIG. 1, and FIG. 3 is a partly broken rear view of the electric lamp of FIG. 1.

In FIGS. 1 to 3, an electric lamp 10 is composed of a light-transmitting bulb 11, a bulb base 14 equipped with a pair of inner terminals 12a,12b and a pair of outer terminals 13a,13b, and linear light-emitting means extended between the inner terminals 12a and 12b. The linear light-emitting means of the electric lamp 10 is composed of two filaments 15a,15b connected in parallel. The filaments 15a,15b are disposed oppositely to each other and shielded from each other with a light transmitting shielding plate 16.

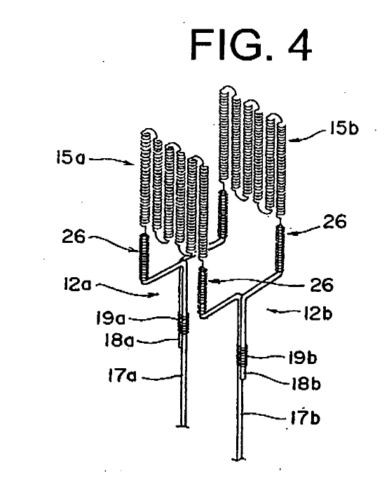

FIG. 4 is a perspective view indicating the connection between the filaments 15a,15b and the inner terminals 12a,12b in the electric lamp 10. FIG. 4 illustrates only the filaments 15a,15b and inner terminals 12a,12b in the electric lamp.

As is illustrated in FIG. 4, the inner terminal 12a is composed of an electrode pole 17a and an auxiliary electrode pole 18a fixed to the electrode pole 17a with a wire 19a. Similarly, the inner terminal 12b is composed of an electrode pole 17b and an auxiliary electrode pole 18b fixed to the electrode pole 17a with a wire 19b.

The filament 15a is extended between the electrode poles 17a and 17b, and the filament 15b is extended between the auxiliary electrode poles 18a and 18b. Thus, the linear light-emitting means of the electric lamp 10 is composed of two filaments 15a,15b connected in parallel and extended between the inner terminals 12a,12b.

Each of the filaments 15a,15b, electrode poles 17a,17b, auxiliary electrode poles 18a,18b, and wires 19a,19b is made of, for example, tungsten.

As is shown in FIG. 1, each of the top and bottom of the filament 15a is supported by the three wires 20a and the two wires 21a. As is shown in FIG. 3, each of the top and bottom of the filament 15b is supported by the three wires 20b and two wires 21b. As is shown in FIG. 2, each of the top and bottom of the light-transmitting shielding plate 16 placed between the filaments 15a and 15b is supported by the two wires 22a and two wires 22b.

The top of the wire 20a, wire 20b and wire 22a are insulated from each other and each is fixed to a upper supporting glass 24a. The bottom of the wire 21a, wire 21b and wire 22b are insulated from each other and each is fixed to a lower supporting glass 24b. Each of the inner terminals 12a,12b is fixed to the lower supporting glass 24b through the electrode pole and auxiliary electrode pole.

To the upper supporting glass 14a and lower supporting glass 24b is fixed a supporting pole 23 extended in the longitudinal direction of the bulb 11. The supporting pole 23 supports the supporting glass 24a,24b. Further, the top of the supporting pole 23 is placed in the indented area of the glass bulb 11 and keeps the electrode poles 17a,17b from deformation due to outer vibration of the electric lamp.

A sleeve glass 25 is placed to cover the base side portion 14 of the electrode pole 17b. The sleeve glass 25 serves to obviate shortage caused by electric contact between the electrode poles 17a and 17b through a filament which has dropped down onto the base 14 from the broken filament.

In the electric lamp 10 of FIGS. 1 to 3, the inner terminal 12a connects with the outer terminal 13a in the inside of the base 14, while the inner terminal 12b connects with the outer terminal 13b in the inside of the base 14. When electric energy is applied to the outer terminal 13a,13b of the lamp 10, both of the two filaments 15a and 15b extended between the inner terminals 12a and 12b emit light at the same time. Since both filaments are caused to emit light simultaneously, one filament continues to emit light when another filament breaks down to cease light emitting and illumination trouble caused by the filament breakage can be minimized.

The light-transmitting shielding plate 16 arranged in the lamp between the filaments 15a and 15b is described.

In the lamp 10 equipped with the shielding plate 16, one filament continues to emit light when another filament breaks down to cease light emitting. If there is not placed the shielding plate 16 between the two filaments 15a and 15b, one filament breaks down simultaneously when another filament breaks down. It is understood that a vapor of material (e.g., tungsten) of one filament produced when the filament breaks down moves to become into contact with another filament and electric discharge takes place on the latter filament and that the electric discharge on the latter filament causes temperature elevation of the filament, resulting in the breakage of the filament. The shielding plate 16 serves to keep the light-emitting filament from the contact with the vapor produced from the broken filament.

It is preferred that the light-transmitting shielding plate is arranged to shield all imaginary lines connecting the filaments 15a,15b disposed oppositely to each other. In other words, it is preferred that all of the imaginary lines connecting an optionally selected site of one filament and an optionally selected site of another filament are shielded by the light-transmitting shielding plate 16. Under this arrangement, the vapor produced from the broken filament is effectively kept from another filament. It is noted that a fixing area 26 (a portion extended from each of the filament 15a,15b and wound around the electrode pole and auxiliary electrode pole) merely serves to fix each filament to the electrode pole and auxiliary electrode pole and is not included in the “filament” defined in the specification.

In the electric lamp 10 in FIGS. 1 to 3, the light-transmitting shielding plate 16 has a length (length in the longitudinal direction of the bulb 11) of 26 mm, a width of 20 mm, and a thickness of 1.5 mm. There is no limitation with respect to the thickness of the light-transmitting shielding plate 16, but the thickness is in the range of 0.1 to 5 mm, from the view point of the practical use.

Representative examples of the material of the light-transmitting shielding plate 16 include glass and light-transmitting alumina. Examples of the glasses include quartz glass, hard glass, and Vycor glass. The light-transmitting shielding glass 16 of the electric lamp 10 in FIGS. 1 to 3 is made of quartz glass.

The light-transmitting shielding plate 16 may have micro-pores therein under such condition that transmission of the vapor from the filament is inhibited.

The light-transmitting shielding plate is preferably heated under reduced pressure for removing volatile components such as water on or in the plate before the plate is placed in the bulb 11.

The linear light-emitting means extended between the inner terminals of the lamp of the invention can be composed of three or more filaments arranged in parallel. In this case, at least one filament and other filament(s) are disposed oppositely to each other and shielded by the light-transmitting shielding plate. When three or more filaments are employed, each filament is preferably shielded from adjacent filaments by a shielding plate.

Two filaments are preferably employed from the view point of practical use. The lamp 10 of FIGS. 1 to 3 is preferably employed as a lighting fitting in a broadcasting studio. In this case, each of the filaments 15a,15b has an electric capacity of 1,000 W.

When two filaments are employed, one filament preferably has an electric capacity lower than an electric capacity of another filament. If the two filaments have different electric capacities, the filament having a lower electric capacity tends to break down earlier than the filament having a higher electric capacity. Therefore, it scarcely happens that both filaments break down simultaneously or successively due to end of their life times. The electric capacity of the filament can be controlled by adjusting thickness of filament, coiling length of filament and the pitch of coiling of filament. The two filaments of the lamp 10 in FIGS. 1 to 3 can be so adjusted that one filament has an electric capacity of 1,200 W and another filament has an electric capacity of 800 W.

If the electric capacity of the filament having a lower electric capacity is extremely lower than the electric capacity of the filament having a higher electric capacity, the filament having a lower electric capacity tends to break down in a short working period of time. Accordingly, it is preferred that the electric capacity of the filament having a lower electric capacity has an electric capacity of 30% or higher based on the electric capacity of the filament having a higher electric capacity.

In addition, it is preferred that one filament has a color temperature higher than a color temperature of another filament so that the two filaments do not break down simultaneously or successively due to end of their life times. The color temperature of the filament can be controlled by thickness of filament, coiling length of filament and the pitch of coiling of filament. The two filaments of the lamp 10 in FIGS. 1 to 3 can be so adjusted that one filament has a color temperature of 3,150 K and another filament has a color temperature of 3,250 K.

If one filament has an extremely high color temperature, as compare with a color temperature of another filament, the filament having a higher color temperature tends to break down within a short working period of time. Accordingly, it is preferred that the difference of color temperature between two filaments is adjusted to be lower than 100 K.

The bulb of the electric lamp preferably contains a halogen gas or a halogen compound gas. An electric lamp containing a halogen gas or a halogen compound gas is generally named a halogen lamp. The bulb and filaments are kept from blackening by incorporating a halogen gas or a halogen compound gas. In addition to the halogen gas or halogen compound gas, a nitrogen gas, an oxygen gas, or an argon gas can be incorporated into the bulb. The electric lamp 10 in FIGS. 1 to 3 contains, for example, gases of halogen compounds (CH₃Br and CH₂Cl₂), an oxygen gas and a nitrogen gas.

The electric lamp of the invention has a bulb base (base or cap) which is equipped with a pair of inner terminals and outer terminals. The bulb base of the lamp of the invention can be a bipost type base equipped with the outer terminal poles 13a,13b (as is shown in FIGS. 1 to 3) or a screw base equipped with a pair of outer terminals.

1-10. (canceled)

11. A method for lighting stages for theaters or concerts or broadcasting studios, comprising the steps of:
providing a halogen lamp comprising a light transmitting bulb, a bulb base equipped with a pair of inner terminals and a pair of outer terminals, a light emitting means composed of plural filaments extended in parallel with each other between the inner terminals, and a halogen gas or halogen compound gas, in which at least one filament and other filament are disposed oppositely to each other and shielded from each other with a light transmitting shielding plate, to lighting fittings;
causing all filaments in the halogen lamp to emit light simultaneously; and
keeping the light emission of other filament when one filament breaks down to cease light emitting.

12. The method of claim 11, in which the light transmitting shielding plate shields all imaginary lines connecting the filaments disposed oppositely to each other.

13. The method of claim 11, in which the light emitting means is composed of two filaments.

14. The method of claim 13, in which the two filaments have the same electric capacity.

15. The method of claim 13, in which one filament has an electric capacity less than an electric capacity of other filament.

16. The method of claim 15, in which the electric capacity of the former filament is 30% or more based on the electric capacity of latter filament.

17. The method of claim 13, in which the two filaments show the same color temperature.

18. The method of claim 13, in which one filament shows a color temperature higher than a color temperature of other filament.

19. The method of claim 18, in which the color temperature of the former filament is higher than the color temperature of the latter filament by 100 K or less.

20. The method of claim 13, in which the halogen lamp comprises a light transmitting bulb, a bulb base equipped with a pair of inner terminals and a pair of outer terminals, halogen gas or halogen compound gas, a lower supporting glass fixed to the top of the inner terminals, a supporting pole fixed to the lower supporting glass at its bottom and extended upwardly, a upper supporting glass fixed to the supporting pole, a light transmitting shielding plate arranged along the supporting pole between the upper supporting glass and the lower supporting glass, one filament extended on one side of the light transmitting shielding plate between one inner terminal and another inner terminal and being hung from the upper supporting glass, and another filament extended on another side of the light transmitting shielding plate between one inner terminal and another inner terminal and being hung from at the upper supporting glass.
